(19) United States
(12) Patent Application Publication
(10) Pub. No.: US 2014/0207544 A1
(43) Pub. Date: Jul. 24, 2014

(54) RANKING LIMITED TIME DISCOUNTS OR DEALS

(71) Applicant: VISAN, INC., Seattle, WA (US)

(72) Inventors: Sanjay Mavinkurve, Seattle, WA (US); Vijay Boyapati, Seattle, WA (US)

(73) Assignee: Visan, Inc., Seattle, WA (US)

(21) Appl. No.: 13/748,483

(22) Filed: Jan. 23, 2013

(51) Int. Cl. G06Q 30/02

(52) U.S. Cl. CPC G06Q 30/0207
USPC 705/14.13; 705/14.1; 705/14.35

(57) ABSTRACT

Briefly, the disclosure describes embodiments of methods or systems for providing an offer to potential recipients based on an appeal score and/or preference indicators of the potential recipients.

### BACKGROUND

1. Field

This disclosure relates to discounts or deals, such as for online users.

2. Information

With the growth of online shopping in recent years, it has become commonplace for merchants to offer products and/or services to potential customers at discounted prices via, for example, an online medium. However, given the relative ease with which a merchant may convey offers for products and/or services to a large number of recipients and the ease with which potential customers may add themselves to a list of recipients, a recipient's electronic mail inbox, for example, may become inundated with offers. This is sometimes referred to as “deal overload.” A recipient, therefore, may view, perhaps on a daily basis, numerous offers for items that may no longer be of interest to the recipient or may not represent a strong value proposition. Thus, in some instances, the recipient may ignore these offers. In other instances, the recipient may find themselves spending an inordinate amount of time sifting through many offers looking for a specific desirable product or service. Deal aggregators have come into existence in an effect to provide some centralization of available deals, but given the sheer number of deals, this appears to add more noise to the system rather than assist users in a meaningful way.

### BRIEF DESCRIPTION OF DRAWINGS

Claimed subject matter is particularly pointed out and distinctly claimed in the concluding portion of the specification. However, both as to organization and/or method of operation, together with objects, features, and/or advantages thereof, claimed subject matter may be understood by reference to the following detailed description if read with the accompanying drawings in which:

FIG. 1 is a schematic diagram of an embodiment of a system to rank limited time discounts or deals;

FIG. 2 shows an example potential recipient entry for an embodiment;

FIG. 3 shows example factors for an embodiment; and

FIG. 4 is a schematic diagram illustrating an embodiment of a computing system capable of ranking limited time discounts or deals.

Reference is made in the following detailed description to accompanying drawings, which form a part hereof, wherein like numerals may designate like parts throughout to indicate corresponding and/or analogous components. It will be appreciated that components illustrated in the figures have not necessarily been drawn to scale, such as for simplicity and/or clarity of illustration. For example, dimensions of some components may be exaggerated relative to other components. It is to be understood that other embodiments may be utilized, Furthermore, structural and/or other changes may be made without departing from claimed subject matter. It should also be noted that directions and/or references, for example, up, down, top, bottom, and so on, may be used to facilitate discussion of drawings and/or are not intended to restrict application of claimed subject matter. Therefore, the following detailed description is not to be taken to limit claimed subject matter and/or equivalents.

### DETAILED DESCRIPTION

In the following detailed description, numerous specific details are set forth to provide a thorough understanding of claimed subject matter. For purposes of explanation, specific numbers, systems, and/or configurations are set forth, for example. However, it should be apparent to one skilled in the relevant art having benefit of this disclosure that claimed subject matter may be practiced without specific details. In other instances, well-known features may be omitted and/or simplified so as not to obscure claimed subject matter. While certain features have been illustrated and/or described herein, many modifications, substitutions, changes, and/or equivalents may occur to those skilled in the art. It is, therefore, to be understood that appended claims are intended to cover any and all modifications and/or changes as fall within claimed subject matter.

Reference throughout this specification to one implementation, an implementation, one embodiment, an embodiment, or the like may mean that a particular feature, structure, or characteristic described in connection with a particular implementation or embodiment may be included in at least one implementation or embodiment of claimed subject matter. Thus, appearances of such phrases, for example, in various places throughout this specification are not necessarily intended to refer to the same implementation or to any one particular implementation described. Furthermore, it is to be understood that particular features, structures, or characteristics described may be combined in various ways in one or more implementations. In general, of course, these and other issues may vary with context. Therefore, particular context of description or usage may provide helpful guidance regarding inferences to be drawn.

It should be understood that for ease of description a hardware device, such as a network device, for example, may be embodied, and/or described in terms of a computing device. However, it should further be understood that this description is intended in in no way to be construed that claimed subject matter is limited to one embodiment, such as a computing device or a network device. Instead, claimed subject matter may be embodied as a variety of devices, including, for example, one or more illustrative examples described herein.

In this context, the term network device refers to any hardware device capable of communicating via and/or as part of a network. Likewise, a computing device refers to any hardware device capable of performing computations, such as arithmetic or logical operations. Network devices may be capable of sending or receiving signals (e.g., signal packets), such as via a wired or wireless network; however, may, in an embodiment, also be capable of performing arithmetic or logic operations, processing or storing signals, such as in memory as physical memory states, and/or may, for example, operate as a client and/or server. Similarly, computing devices may be capable of processing or storing signals, such as in memory as physical memory states, and/or may, for example, operate as a client and/or server. Likewise, a computing device in an embodiment may be capable of sending or receiving signals.

A network may comprise two or more network devices and/or may couple network devices so that signal communications, such as in the form of signal packets, for example, in an embodiment may be exchanged, such as between a server and a client device or other types of network devices, including between wireless devices coupled via a wireless network, for example.

A network may also include now known, or to be later developed arrangements, derivatives, and/or improvements, including, for example, past, present or future mass storage, such as network attached storage (NAS), a storage area network (SAN), or other forms of computer or machine readable media, for example. A network may include the Internet, one or more local area networks (LANs), one or more wide area networks (WANs), wire-line type connections, wireless type connections, other connections, or any combination thereof. Likewise, sub-networks, such as may employ differing architectures or may be substantially compliant or substantially compatible with differing protocols, such as communication protocols (e.g., network communication protocols), may interoperate within a larger network. Various types of network devices may be made available so that device interoperability is enabled and/or, in at least some instances, may be transparent to the devices. In this context, the term transparent refers to network devices communicating via a network in which the devices are able to communicate via intermediate network devices, but without the communicating devices necessarily specifying one or more intermediate devices and/or may include communicating as if intermediate devices are not necessarily involved in communication transmissions.

The Internet refers to a decentralized global network of interoperable networks. The Internet includes local area networks (LANs), wide area networks (WANs), wireless networks, or long haul public networks that, for example, may allow signal packets to be communicated between LANs. Signals, such as packets, also referred to as signal packet transmissions, may be communicated between nodes of a network, where a node may comprise one or more network devices, for example. As an illustrative example, but without limitation, a node may comprise one or more sites employing a local network address. A signal packet may, for example, be communicated via a communication channel or a communication path comprising the Internet, from a site via an access node coupled to the Internet. Likewise, a signal packet may be forwarded via network nodes to a target site coupled to a local network, for example. A signal packet communicated via the Internet, for example, may be routed via a path comprising one or more gateways, servers, etc. that may, for example, route a signal packet in accordance with a target address and availability of a network path to a target address.

As mentioned, with growth of online shopping in recent years, it has become commonplace for merchants to offer products and/or services to potential customers at discounted prices via, for example, an online medium. Use of an online clearinghouse, for example, may allow a merchant to liquidate nonperforming inventory or to boost sales while providing customers with high-quality products and/or services at discounts. A clearinghouse or deal provider may maintain an extensive electronic mail list of potential customers who may be interested in obtaining discounted products and/or services and/or a website posting deals as well. Thus, by utilizing an online deal provider, for example, a merchant may be able to liquidate a warehouse of products, for example, within a relatively short time, even within a few days or less, in a manner that may also benefit consumers. Of course, claimed subject matter is not limited in scope to use of a clearinghouse, which is provided here merely for illustration purposes.

If a merchant desires to reduce inventory and/or acquire new customers, just to name a few non-limiting examples, the merchant may offer discounted products and/or services to an audience of potential customers. In some implementations, a merchant may provide details or “features” of an offer for discounted products and/or services, referred to here as “a deal”, “a discount” and/or “discount deal.” Typically, a discount or deal may be available for a limited time. A merchant may employ a sourcing agent to distribute discounts or deals. A sourcing agent may comprise a deal provider, such as a regional representative, who may perform outsourcing activities on behalf of a merchant, in this case, distribution of discounts or deals. A sourcing agent may typically, but not necessarily, comprise an agent deal provider for a host of merchants.

In an implementation, a sourcing agent may prepare, as a result, an electronic communication for distribution to a list of recipients that includes a discount or discount deal as well as website posting. In this context, the term electronic communication refers to any communication capable of being transmitted and/or received via a network. For example, a push type electronic communication mechanism, such as email or the like, may be used, or a pull type electronic communication mechanism, such as a website, may be used. A recipient, for example, may purchase a deal or discount, if purchase is applicable, in which the deal or discount may be embodied in an electronic communication, for example. To consummate a deal, a recipient may print an electronic communication and present it in the form of a voucher to a particular merchant to receive a discounted product or service. In this context, a discount or deal, whether for purchase or available without charge, for presentation to a merchant so as to consummate a discount or deal, whether in print form, electronic form or another form, may be referred to as a voucher. For example, a smart phone may provide an image, such as a pdf or other type of image that may operate as a voucher. Of course, vouchers may typically be tracked for a variety of reasons, including accounting, reimbursement, service fees, etc., such as via a coding scheme or other mechanism. In other implementations, a recipient may communicate with a merchant by way of a website, which may likewise result in an electronic communication, discount deal, and voucher, for example.

Over time, however, a recipient may acquire enough of a particular product, for example, or may make use of services to the extent that he or she is no longer interested in receiving deals electronically or in monitoring a website. Thus, as suggested previously, a recipient may choose to “unsubscribe” or may begin to ignore electronic communications. Thus, a recipient may foreclose future opportunities. In such instances, not only may potential recipients fail to benefit, also merchants or other deal purveyors additionally may miss opportunities. The terms potential recipient, user or similar terms are used interchangeable through this document unless particular usage in context suggests otherwise.

Varieties of technical challenges exist to address a situation, such as the one described. Customization for potential recipients is one example of a potential challenge. Likewise, a capability to process large amounts of discounts in a sufficiently short time span to be of value to potential recipients (e.g., before a validity period expires) is another potential challenge. Accordingly, it may be useful to employ a special-purpose computing platform that may rank discount or deals, such as, for example, in an embodiment, based at least in part on one or more factors, as described in more detail below.

A potential benefit to a potential recipient or user may be in terms of a ‘time value proposition.’ In general, a potential recipient may receive or have access to too many discounts or deals for it to be economically justifiable to sift through them all to uncover those of value within the short period of time in which the deals or discounts remain valid. That is, the potential savings from the discount or deal, for example, may be less by than the value of the time actually spent sifting, assuming further it is even feasible to do so before the deals or discounts expire, which may be a challenge itself. However, a service or similar mechanism that is able to perform a similar sifting operation for a user or potential recipient in a timely manner, so that a potential recipient has a much small number of discounts to consider and would likewise be able to consummate a deal in a timely fashion if desired, may provide value to users, for example.

Ranking of discounts or deals may employ a variety of factors, as discussed below, including personal preference-type factors to indicate a potential recipient's preferences. Furthermore, in some implementations, weighting factors for a potential recipient may indicate that certain personal preference-type factors, also referred to here as preference-related indicators, may be more favorable. Thus, relative degree of favor may be implemented in an embodiment. Likewise, negative weighting may provide a mechanism so that unfavorable personal preference-type factors may also be considered in an embodiment. In some implementations, as an example, a potential recipient may indicate personal preference-related factors, expressly or implicitly. A potential recipient may voluntarily answer questions or provide browsing behavior of a potential recipient may be evaluated, as respective examples of expressly communicated personal preference-type factors or implicitly communicated personal preference-type factors.

Thus, as an example embodiment, a ranking of discount or deal scores may take place as follows. Computation of scores may take place across a host of discounts for a host of potential recipients using a host of factors. Scoring of discounts or deals may, therefore, take into account a variety of factors. For example, scoring may include personal preference-type factors, factors not necessarily specific to users, or both. Factors may use weights specific to a particular user or weights that represent collectively assessed preferences among a potential customer population, depending at least in part on the embodiment. Likewise, a particular factor for a particular deal may have a numerical value on a scale representative for that factor, the numerical value to be used with an associated weight. For example, in an illustrative embodiment, a deal or discount evaluated with respect to a user may comprise a sum of products or similar computation in which a product comprises a factor weight for that deal and that recipient multiplied by a numeral measurement of the particular factor for that deal and that user. Of course, claimed subject matter is not limited in scope to illustrative examples, such as discussed previously or later.

For example, the more proximate a merchant offering a discount deal may be to a potential recipient, the higher numerical value a discount deal may receive for the particular factor evaluated for that deal with respect to that potential recipient. Likewise, a potential recipient may demonstrate a higher preference for proximity compared with other potential recipients, also resulting in a higher weight for that potential recipient in comparison with other potential recipients. Discount deals may therefore receive a discount or deal score and a ranking of scores may take place for a potential recipient, for example. Discount deals may fall within a top number of discounts within a particular time, such as, such as the top ten deals for that day, as a non-limiting example. Potential recipients may obtain or receive communications regarding those top discounts for that day. It is, of course, appreciated that this is merely an example for illustration and claimed subject matter is not limited in scope to illustrative examples.

Within the embodiment framework described above, however, as previously indicated, a host of factors of various types may be considered. Furthermore, there is not an exclusive list of factors to consider for an embodiment. For example, additional factors not discussed herein may be employed. Furthermore, different sets of factors may be employed to produce different rankings. For example, a ranking may exclude personal preference-type factors to produce a list of top deals irrespective of personal user preference, for example. In an embodiment, for example, weights not particular to an individual may be employed. Likewise, weights need not necessarily be used in in embodiment. Furthermore, different factor scales may implicitly include weights, such as where one factor is on a scale from one to ten and another is on a scale from one to twenty, effectively having the potential to weigh one factor as half of another.

Continuing with an example embodiment, a special-purpose computing platform may be employed to compute a deal score or a discount score, which, in an embodiment, may employ factor metrics for example. As simply examples, a score (e.g., deal score) may be at least partially affected by a number of recipients that have accepted similar deals, a velocity of sales for a deal, and/or other parameters that may, for example, be unrelated to preference-related indicators for a particular potential recipient. In some implementations, a score may include contributions or be affected at least in part by stored information available from proprietary or from public websites or databases. For example, a local government database may indicate complaints to the local public health department. As additional examples, in an implementation, a publicly available commercial website or database, such as Zagat, and/or Yelp, for example, may comprise a factor that may affect a deal score. Again, these are merely illustrative examples and claimed subject matter is not limited in scope to illustrations.

In an example embodiment, a method for ranking a list of deals offered by a plurality of merchants to a population of potential recipients (e.g., potential customers) may include the following. A list of deals may be acquired, such as by using an automated crawler or similar mechanism. Web crawlers and web crawler technology is well known and need not be discussed further. Deals obtained may be ranking substantially in accordance with a ranking function. A ranking function may take into account factors that cut across a population of potential recipients and factors that may be particular to one or a few potential recipients. After having a set of ranked deals, some rankings may reflect particular preferences and some rankings may not. Top deals of various rankings may be communicated in an embodiment.

Deal relevance and/or deal quality may be assessed in several ways. In this context, quality may be measured in terms of popularity of a deal. In general, over a large enough sample, the more popular one deal is than another, the more likely that that the more popular deal is higher in quality from a user perspective. The term relevance is generally understood to mean of interest or use to a potential recipient. As suggested, in one possible embodiment, a ranking function may compute a score. For at least one embodiment, scoring may be at least partially influenced by such things as the following.

Social Appeal.

How many people have “shared” a deal with their friends or family, or “liked” a deal by using a social network such as Facebook or Google Plus (on Google Plus the term “+1” is used instead of “like”) may reflect deal popularity or quality. Note that this factor is not limited to individual social graphs and, instead, includes a host of social graphs for a population of potential recipients.

Sales Volume.

Another factor in scoring may include how many people have purchased a deal. All things being equal, a deal purchased by more people is more likely to be higher quality than a deal purchased by fewer people.

Sales Velocity.

Another factor in scoring may comprise how quickly sales volume is growing. A deal for which a large number of vouchers have recently been sold is more likely to be of higher quality than a deal for which few vouchers have recently been sold. For example, rate of change, in particular, may be of interest.

Merchant Quality.

Yet another factor in scoring comprises a rating of the merchant who is offering a deal through a deal-provider. A rating is available for many merchants through services such as Yelp or Zagat. Yelp, for instance, allows users of its service to rate merchants from 1 to 5 stars, and averaged ratings are provided.

Deal Provider Quality.

Still another factor comprises rating of a deal provider. This factor may be more useful where the above factors may not be available (for instance, some merchants may not have a Yelp review). Deal provider quality in one embodiment may be measured by taking an average score” over deals offered by a deal provider.

One benefit of a ranking function includes combining these various measures for a deal into a score so that deals are able to be ranked for quick assessment of top deals by a user, for example. Deals to be ranked typically are offered by a deal provider on their website and via a specific URL, as indicated previously. Thus, in an embodiment, a score may be computed in the following manner. Specified URLs may be ‘crawled’ for given deals, thereby obtaining textual content for specific deal offers. Using pattern matching, content may be extracted, such as name of merchant offering the deal, merchant phone number, merchant address and number of vouchers that have been sold for the deal (deal providers may provide the number of vouchers sold for a deal on the webpage of the deal as a way of generating excitement that the deal is popular). Sometimes, of course, not all of these fields will be available.

Using an “application programming interface” (API), the number of times a deal has been “liked” or “shared” may be measured using a social network, such as Facebook. In an embodiment, for example, an API may take a URL as input and return a number of “likes” and “shares” for a given deal. Likewise, using an API, a rating of a merchant using a review service, such as Yelp, may be determined. An API may take a merchant's name and merchant's address or phone number (these variables may be obtained as previously described, for example) and return a rating along with a number of reviews a merchant has received.

After performing the above operations, the following is available for a deal: the number of times the deal has been “liked” (L) and “shared” (S), the total number of vouchers sold for a given deal (V), and the rating (R) of the merchant offering the deal, along with the number of people who reviewed the merchant (N). This content may be collected periodically per deal, for example. Likewise, velocity of sales volume (Q) may be computed if sufficient content is available, e.g., rate of change of sales volume, referred to here as Q.

In an embodiment, it may be desirable in some instances to normalize for comparison across deals. For example, deal providers have different numbers of subscribers. A deal provider such as Groupon, through its leading market position, may be likely to sell more vouchers per deal than a much smaller deal provider because Groupon has more subscribers. Thus, for example, a deal for which 100 vouchers are sold may be below average for Groupon, but above average for a smaller deal provider. In an embodiment, one approach comprises computing average number of “likes” (a-L), “shares” (a-S) and vouchers sold (a-V) for a deal provider per city. For a deal to be ranked, again, in this example embodiment, its number of likes, shares and vouchers sold may be computed for comparison to an average for that deal provider in that city. Thus, if Groupon sells on average 200 vouchers per deal in Seattle and a particular deal offered by Groupon in Seattle sells 800 vouchers, the deal will have 4 times as many vouchers sold as its average for the city and deal provider. Thus, a multiple may be computed from average number of likes, shares and vouches, referred to here as m-L, m-S and m-V respectively, where m-L=L/a-L, m-S=S/a-S and m-V=V/a-V.

In an embodiment, a composite Yelp score (Y) may also be computed. By itself, a Yelp star-rating (R) may not be sufficient to measure quality of a merchant. A newly established restaurant, for example, may have a rating of 5 stars (the highest rating) on Yelp, but may only have a handful of reviews. The number of reviews (N) may increase confidence in a Yelp rating, plus it may signal a higher quality for the merchant in and of itself. That is, a merchant with hundreds of reviews has been patronized by many customers who apparently have felt an urge to review it. Thus, it is a measure of popularity. To compute a Yelp score, in an embodiment, a product of a Yelp star-rating R with a logarithmic function of N may be determined. A logarithmic function reflects that as the number of Yelp reviews grow, the marginal benefit (in terms of the credibility that the number of reviews lends to the star-rating) of an additional review diminishes. For example, a 4-star restaurant with 200 reviews may not be significantly better than a 4-star restaurant with 180 reviews. However, a 4-star restaurant with 25 reviews may, on average, be better than a 4-star restaurant with only 5 reviews (even though in both cases, the difference in the number of reviews is 20). In this example illustration, to compute a deal score, a weighted product of m-L, m-S, m-V and Y is calculated. To this score, a boosting factor may be multiplied if velocity of sales (Q) is above a threshold in an embodiment.

Likewise, in an embodiment, weights assigned to factors may be qualitatively evaluated using standard machine learning techniques. Since machine learning is well understood, it is not believed that further discussion is required. After deal scores are computed, deals may be communicated, via email, text, etc. (push-type) or via a website (pull-type) for example, ranked according to score per city, allowing users to see top deals without reviewing an entire, typically long, list of deals.

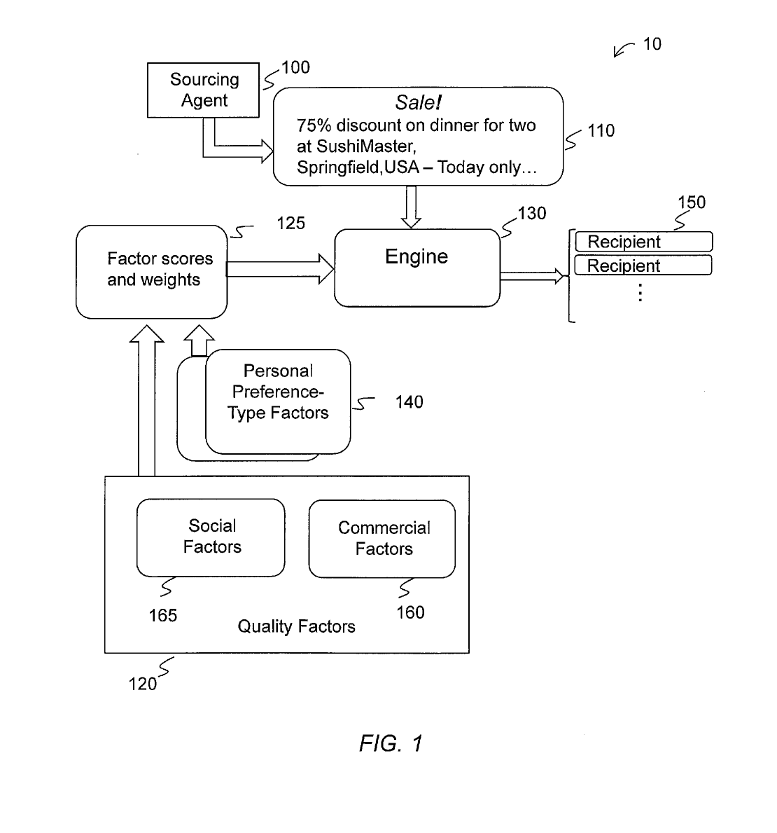

FIG. 1 is a schematic diagram of an embodiment 10 of a system for ranking limited time discounts or deals. In FIG. 1, sourcing agent 100 represents any source of online or electronically available deals, such as from a merchant, a clearinghouse, or other deal provider, for example. As suggested, in an embodiment, a web crawler or other computer program may browse the World Wide Web in a methodical, automated manner or in some other orderly fashion to locate sourcing agent deals or discounts. Thus, in some implementations, a web crawler or other mechanism may detect deals, for example, by crawling the web for electronic content. Electronic contact may comprise any type of content, such as a web page, a portable document formatted (PDF) file, or the like, and claimed subject matter is not limited in this respect.

An electronic communication, such as 110 of FIG. 1, may represent a deal or discount available from sourcing agent 100, for example, in an embodiment. For example, as indicated previously, deals may be posted on a website. Deal or electronic communication 110 may comprise a list of various features that identify parameters of a deal, such as, for example, a numerical amount corresponding to a discount (e.g., 75%), an item for purchase (e.g., dinner for two), a name of a merchant (e.g. SushiMaster), a validity period (e.g., today only), and a location of the merchant (e.g., Springfield, USA). As previously discussed, features may be extracted using pattern matching or other similar technology. For example, it may be readily apparent from HTML for a web page how to extract desired content.

Deals or discounts of various forms may be utilized in various implementations and may comprise numerous other features such as quantity-related parameters (e.g., “buy one, get one free”), conditions as to a number of deals that will be accepted by a merchant (e.g., “First 50 customers receive a prize”), and/or numerous other variations and/or combinations. It should be noted that an electronic communication, such as 110, is but one form of representation of a deal, and claimed subject matter is not limited in this respect. Deal 110 may be conveyed to engine 130 via the Internet or other communications network, for example, as a result of crawling the web and extracting content, as described above.

Engine 130 may be implemented, for example, by way of one or more processors executing a computer program to perform comparisons of deals based at least in part on computations with respect to features extracted from various deals, such as deal 110, with one or more sets of factors, such as quality factors 120, which, as shown, may, in this example, comprise commercial factors 160 and/or social factors 165, and which may comprise personal preference-type factors 140 for potential recipients.

In an implementation, a set of personal preference-type factors 140 may comprise preferences for potential recipients, wherein, for an embodiment, a one-to-one correspondence may exist between a set of preference-related factors 140 and a potential recipient. Thus, in one possible example, a potential recipient may voluntarily indicate, expressly or implicitly, that he or she is prefers receiving deals concerning dining out, groceries, and so forth. In implementations, weighting factors and factor scores 125 may be used, for example, to perform computations for certain types of deals based at least in part on a set of factors with respect to various products and/or services, such as personal preference-type factors. In the example of FIG. 1, engine 130 may also perform comparisons of deals based at least in part on computations using quality factors 120, as mentioned previously. In implementations, quality factors 120 may comprise parameters that are not necessarily personal to a particular potential recipient. Thus, deals may be communicated to recipients based at least in part on quality factors 120, based at least in part on preference-related factors 140, or based at least in part on various combinations of factors. Again, as illustrated by 125 in FIG. 1, weights and scaling for these various approaches may be employed. Likewise, in other implementations, deals may be communicated to recipients based at least in part on additional factors and/or indicators, and claimed subject matter is not limited in this regard.

Quality factors, as has been illustrated and discussed, may be influenced by, for example, signals from public or proprietary sources, such as commercial and/or government websites and/or databases 160, for example. Yelp has been discussed as one example. As another example, public health department reports, available through a database or website, may be used to formulate a factor affecting deal score based at least in part on inspection results, customer complaints, or lack thereof, and so forth. Further, as already suggested, commercial databases 160 may comprise a publicly available commercial website or database, such as a Zagat, and/or Yelp, Google+, which may be utilized to formulate a factor affecting deal score.

After processing signals or stored states representing quality factors 120 and/or preference-related factors 140, a ranking may be communicated. Recipients may comprise users who visit a website (pull-type) or, in an implementation, recipients 150 may represent particular individuals for whom features approach or agree with one or more preference-related indicators of a set of preference-related factors 140 (e.g., within a threshold amount for example). Additionally or alternately, recipients 150 may receive a communication if deal scores approach or meet a score threshold, which may, for example, be specified externally, such as by the potential recipients, or specified internally, e.g., selected by a deal aggregator implementing ranking, or another mechanism. Thus, for example, a score threshold may be calculated by engine 130 or by another process, for example, although claimed subject matter, of course, is not limited in this respect.

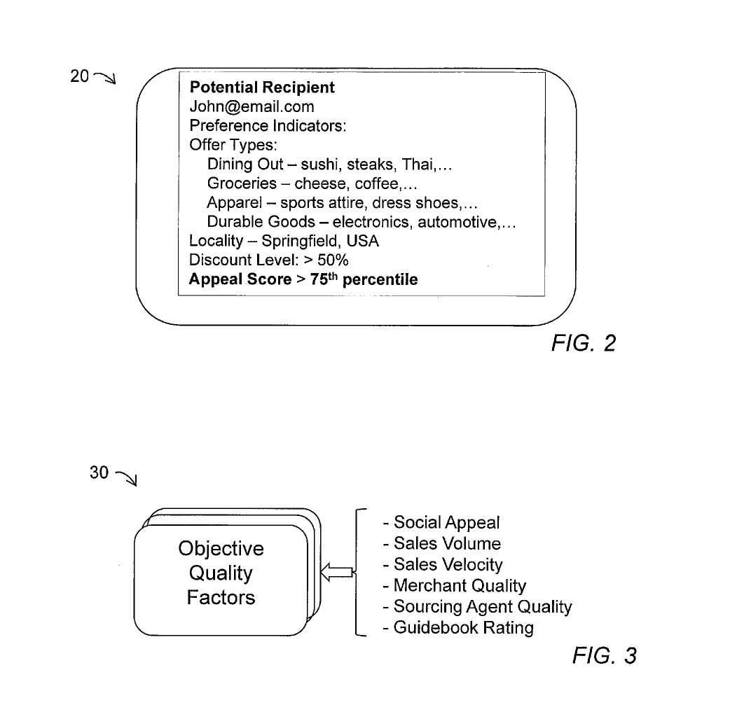

FIG. 2 shows an example embodiment entry 20 of a set of preference indicators for a potential recipient, such as discussed in connection with FIG. 1. As shown in FIG. 2, a potential recipient “John” may receive rankings of deals, perhaps represented similarly to 110 of FIG. 1, for example, at an e-mail address “John@email.com.” In FIG. 2, a potential recipient, for example, has indicated the product and/or service categories in which he or she may be interested, such as Dining Out (including sushi, steaks, That food, etc.), Groceries (including cheese, coffee, etc.), Apparel (including sports attire, dress shoes, etc.), Durable Goods (including electronics, automotive, etc.). Likewise, if “John” were to visit a website, he could similarly indicate interest in particular categories and/or perform key word searching of a ranked set of deals in connection with browsing of rankings. Along these lines, experimental or non-traditional categories, such as “once in a life time” or “date night” may be employed to see if deal score might be affected positively for potential recipients.

A potential recipient, such as shown in FIG. 2, has also indicated an interest in deals in a certain locality or proximity, such as Springfield, USA. Additionally, a potential recipient has indicated that he or she may be interested in a discount level greater than 50%, which may signify that a potential recipient prefers discounts of at least one-half off regular prices. Likewise, one may alternately specify a desire to only view deals that do not require purchase of the deal from the deal provider. Further, a potential recipient may indicate a desire for a score corresponding to greater than the 75th percentile. In implementations, this may signify that the potential recipient may prefer deals for which quality factors contribute to a score that is superior to 75% of the currently available deals, for example, after ranking.

In certain implementations, preference-related indicators may be associated with weighting factors for a particular potential recipient, which may suggest that certain indicators may be favored over others. In one possible example, a potential recipient may designate a score of greater than the 90th percentile, for example, as having 3.0 times the preference of any other preference-related indicator. As a result, engine 130 of FIG. 1, for example, may determine a ranking taking into account such preferences. In another possible example, a potential recipient who may consider himself/herself to be a coffee aficionado, may more heavily weight deals for discounts on coffee than other products and/or services.

It should be noted that the above discussion identifies but a few examples of a large number of personal preference-type factors and/or quality factors; and claimed subject matter is intended to embrace all such types and/or forms of factors. Additionally, engine 130 may have access to, perhaps thousands or even millions of preference-related indicator sets corresponding to a large number of potential recipients, such as via a public or via a proprietary database, for example.

FIG. 3 shows an example of an embodiment 30 of factors at least some, if not all, of which may be considered quality factors. As previously discussed in an example, social appeal, sales volume, sales velocity, merchant quality, and deal provider quality may be employed to compute a deal score for a variety of deals. Likewise, if preference-related indicators are available, this may be done across a host of potential recipients to produce a variety of deal rankings capable of being communicated.

In FIG. 3, a social appeal may pertain, for example, to any one of numerous social appeal metrics. A variety of measures were previously discussed. In yet another example, a social appeal metric may be related to a number of “Tweets” pertaining to a particular offer and claimed subject matter is not limited in this respect. Implementations may also utilize a metric related to merchant quality. Examples were previously discussed. As another example, merchant quality may, for example, be related to a percentage of customers satisfied with the particular merchant. Accordingly, in an example, a merchant that has achieved a 99% favorable rating may contribute to a higher score than a merchant that has achieved an 85% favorable rating. In implementations, guidebook ratings may also at least partially affect a deal score. In one example, a deal for dining at a restaurant scoring relatively high in a guidebook, or an online equivalent to a guidebook, may contribute to higher score than, for example, a deal for dining at a restaurant having a lower guidebook score. In another implementation, a restaurant having an unresolved customer complaint, or having an unaddressed complaint from a local public health department may contribute to a lower score.

In implementations, at least some metrics may be normalized to reduce risk of skewing, although this may vary with the particular metric. For example, one example of a non-limiting approach to normalization of Yelp scores was previously discussed. In other examples, normalizing functions other than those having logarithmic profiles may be utilized, such as Gaussian normalization, unity-based normalization, etc., and claimed subject matter is, of course, not limited in this regard. A wide variety of approaches to normalization exist or may be developed and it is intended that they be covered by claimed subject matter.

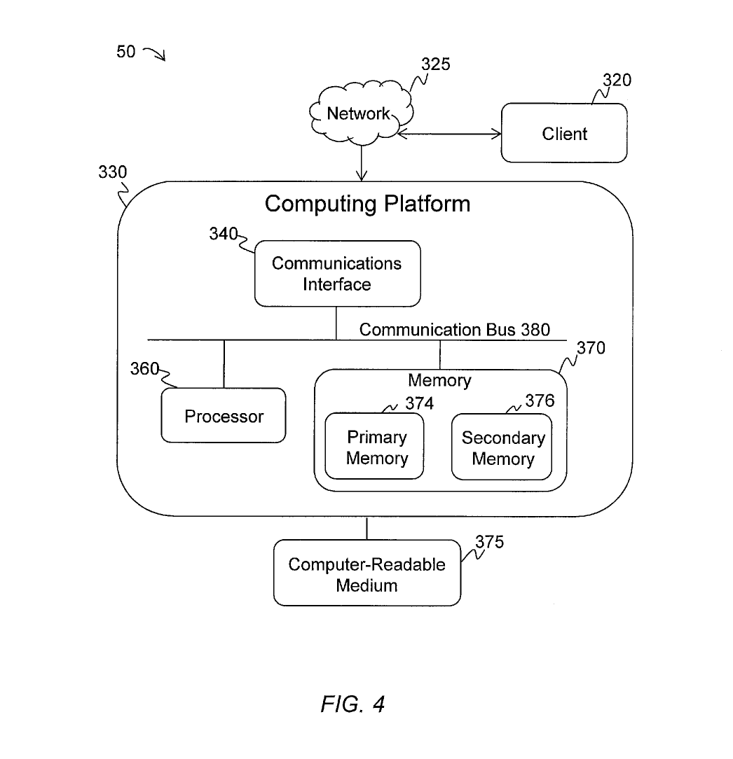

FIG. 4 is an illustration of an embodiment of a computing platform 50 that may be employed for example to perform ranking of limited time discounts. In FIG. 4, computing platform 330 may interface with client 320, which may comprise features of a conventional client device, for example. Communications interface 340, processor (e.g., processing unit) 360, and memory 370, which may comprise primary memory 374 and secondary memory 376, may communicate by way of communication bus 380, for example. In FIG. 4, client 320 may represent one or more or more sources of analog, uncompressed digital, lossless compressed digital, or lossy compressed digital formats for content of various types, such as video, imaging, text, audio, etc. in the form physical states or signals, for example. Client 320 may communicate with computing platform 330 by way of an Internet connection via network 325, for example. Although the computing platform of FIG. 4 shows the above-identified elements, claimed subject matter is not limited to computing platforms having only these elements as other implementations may include alternative arrangements that may comprise additional components, fewer components, or components that function differently while achieving similar results. Rather, examples are provided merely as illustrations. It is not intended that claimed subject matter to limited in scope to illustrative examples.

Processor 360 may be representative of one or more circuits, such as digital circuits, to perform at least a portion of a computing procedure or process. By way of example but not limitation, processor 360 may comprise one or more processors, such as controllers, microprocessors, microcontrollers, application specific integrated circuits, digital signal processors, programmable logic devices, field programmable gate arrays, and the like, or any combination thereof. In implementations, processor 360 may perform signal processing to manipulate signals or states or to construct signals or states, for example. Memory 370 may be representative of any storage mechanism.

Memory 370 may comprise, for example, primary memory 374 and secondary memory 376, additional memory circuits, mechanisms, or combinations thereof may be used. Memory 370 may comprise, for example, random access memory, read only memory, or one or more data storage devices or systems, such as, for example, a disk drive, an optical disc drive, a tape drive, a solid-state memory drive, just to name a few examples. Memory 370 may be utilized to store a program, such as one to perform ranking of limited time discounts, as an example. Memory 370 may also comprise a memory controller for accessing computer readable-medium 375 that may carry and/or make accessible content, code, and/or instructions, for example, executable by processor 360 or some other controller or processor capable of executing instructions, for example.

Under the direction of processor 360, memory, such as cells storing physical states, representing for example, a program, may be executed by processor 360 and generated signals may be transmitted via the Internet, for example. Processor 360 may also receive digitally-encoded signals from client 320.

Network 325 may comprise one or more communication links, processes, and/or resources to support exchanging communication signals between a client, such as 320 and computing platform 330, which may, for example, comprise one or more servers (not shown). By way of example, but not limitation, network 325 may comprise wireless and/or wired communication links, telephone or telecommunications systems, Wi-Fi networks, Wi-MAX networks, the Internet, the web, a local area network (LAN), a wide area network (WAN), or any combination thereof.

The term “computing platform,” as used herein, refers to a system and/or a device, such as a computing device, that includes a capability to process and/or store data in the form of signals and/or states. Thus, a computing platform, in this context, may comprise hardware, software, firmware, or any combination thereof (other than software per se). Computing platform 430, as depicted in FIG. 4, is merely one such example, and the scope of claimed subject matter is not limited to this particular example. For one or more embodiments, a computing platform may comprise any of a wide range of digital electronic devices, including, but not limited to, personal desktop or notebook computers, high-definition televisions, digital versatile disc (DVD) players and/or recorders, game consoles, satellite television receivers, cellular telephones, personal digital assistants, mobile audio and/or video playback and/or recording devices, or any combination of the above. Further, unless specifically stated otherwise, a process as described herein, with reference to flow diagrams and/or otherwise, may also be executed and/or affected, in whole or in part, by a computing platform.

Memory 370 may store cookies relating to one or more users and may also comprise a computer-readable medium that may carry and/or make accessible content, code and/or instructions, for example, executable by processor 360 or some other controller or processor capable of executing instructions, for example. A user may make use of an input device, such as a computer mouse, stylus, track ball, keyboard, or any other device capable of receiving an input from a user.

A wireless network may couple client devices, such as 320 as an example, with a network. A wireless network may employ stand-alone ad-hoc networks, mesh networks, Wireless LAN (WLAN) networks, cellular networks, or the like. A wireless network may further include a system of terminals, gateways, routers, or the like coupled by wireless radio links, or the like, which may move freely, randomly or organize themselves arbitrarily, such that network topology may change, at times even rapidly. Wireless network may further employ a plurality of network access technologies, including Long Term Evolution (LTE), WLAN, Wireless Router (WR) mesh, or second, 3rd, or 4th generation (2G, 3G, or 4G) cellular technology, or other technologies, or the like. Network access technologies may enable wide area coverage for devices, such as client devices with varying degrees of mobility, for example.

A network may enable radio frequency or wireless type communications via a network access technology, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, or other, or the like. A wireless network may include virtually any type of now known, or to be developed, wireless communication mechanism by which signals may be communicated between devices, such as a client device or a computing device, between or within a network, or the like.

Communications between a computing device and a wireless network may be in accordance with known, or to be developed cellular telephone communication network protocols including, for example, global system for mobile communications (GSM), enhanced data rate for GSM evolution (EDGE), and worldwide interoperability for microwave access (WiMAX). A computing device may also have a subscriber identity module (SIM) card, which, for example, may comprise a detachable smart card that stores subscription information of a user, and may also store a contact list of the user. A user may own the computing device or may otherwise be its primary user, for example. A computing device may be assigned an address by a wireless or wired telephony network operator, or an Internet Service Provider (ISP). For example, an address may comprise a domestic or international telephone number, an Internet Protocol (IP) address, or other identifiers. In other embodiments, a communication network may be embodied as a wired network, wireless network, or combination thereof.

A network or a computing device may vary in terms of capabilities or features. Claimed subject matter is intended to cover a wide range of potential variations. For example, a network or a computing device may include a numeric keypad or a display of limited functionality, such as a monochrome liquid crystal display (LCD) for displaying text. In contrast, however, as another example, a web-enabled computing device may include a physical or a virtual keyboard, mass storage, one or more accelerometers, one or more gyroscopes, global positioning system (GPS) or other location-identifying type capability, or a display with a higher degree of functionality, such as a touch-sensitive color 2D or 3D display, for example.

A computing device may include or may execute a variety now known, or to be developed operating systems, or derivatives and/or versions, including personal computer operating systems, such as a Windows, iOS or Linux, or a mobile operating system, such as iOS, Android, or Windows Mobile, or the like. A computing device may include or may execute a variety of possible applications, such as a client software application enabling communication with other devices, such as communicating one or more messages, such as via email, short message service (SMS), or multimedia message service (MMS), including via a network, such as a social network including, but not limited to, Facebook, LinkedIn, Twitter, Flickr, or Google+, to provide only a few examples. A computing device may also include or execute a software application to communicate content, such as, for example, textual content, multimedia content, or the like. A computing device may also include or execute a software application to perform a variety of possible tasks, such as browsing, searching, playing various forms of content, including locally stored or streamed video, or games such as, but not limited to, fantasy sports leagues. The foregoing is provided merely to illustrate that claimed subject matter is intended to include a wide range of possible features or capabilities.

It will, of course, be understood that although particular embodiments will be described, claimed subject matter is not limited in scope to a particular embodiment or implementation. For example, one embodiment may be in hardware, such as implemented to operate on a device or combination of devices, for example, whereas another embodiment may be in software. Likewise, an embodiment may be implemented in firmware, or as any combination of hardware, software, and/or firmware, for example (other than software per se). Likewise, although claimed subject matter is not limited in scope in this respect, one embodiment may comprise one or more articles, such as a storage medium or storage media. Storage media, such as, one or more CD-ROMs and/or disks, for example, may have stored thereon instructions, executable by a system, such as a computer system, computing platform, or other system, for example, that may result in an embodiment of a method in accordance with claimed subject matter being executed, such as a previously described embodiment, for example; although, of course, claimed subject matter is not limited to previously described embodiments. As one potential example, a computing platform may include one or more processing units or processors, one or more devices capable of inputting/outputting, such as a display, a keyboard and/or a mouse, and/or one or more memories, such as static random access memory, dynamic random access memory, flash memory, and/or a hard drive.

Likewise, in this context, the terms “contact,” “coupled” or “connected,” or similar terms, may be used. It should be understood that these terms are not intended as synonyms. Rather, “connected” may be used to indicate that two or more elements or other components, for example, are in direct physical or electrical contact; while, “contact” or “coupled” may mean that two or more elements are in direct physical or electrical contact; however, “contact” or “coupled” may also mean that two or more elements are not in direct contact, but may nonetheless co-operate or interact. The term coupled or contact may also be understood to mean indirectly connected or in indirect contact, for example, in an appropriate context.

The terms, “and”, “or”, and “and/or” as used herein may include a variety of meanings that also are expected to depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein may be used to describe any feature, structure, and/or characteristic in the singular and/or may be used to describe a plurality or some other combination of features, structures and/or characteristics. However, it should be noted that this is merely an illustrative example and claimed subject matter is not limited to this example.

In the preceding detailed description, numerous specific details have been set forth to provide a thorough understanding of claimed subject matter. However, it will be understood by those skilled in the art that claimed subject matter may be practiced without these specific details. In other instances, methods and/or apparatuses that would be known by one of ordinary skill have not been described in detail so as not to obscure claimed subject matter. Some portions of the preceding detailed description have been presented in terms of logic, algorithms, and/or symbolic representations of operations on binary signals or states, such as stored within a memory of a specific apparatus or special-purpose computing device or platform. In the context of this particular specification, the term specific apparatus or the like includes a general-purpose computing device, such as general-purpose computer, once it is programmed to perform particular functions pursuant to instructions from program software.

Algorithmic descriptions and/or symbolic representations are examples of techniques used by those of ordinary skill in the signal processing and/or related arts to convey the substance of their work to others skilled in the art. An algorithm is here, and generally, is considered to be a self-consistent sequence of operations and/or similar signal processing leading to a desired result. In this context, operations and/or processing involve physical manipulation of physical quantities. Typically, although not necessarily, such quantities may take the form of electrical and/or magnetic signals and/or states capable of being stored, transferred, combined, compared, processed or otherwise manipulated as electronic signals and/or states representing information. It has proven convenient at times, principally for reasons of common usage, to refer to such signals and/or states as bits, data, values, elements, symbols, characters, terms, numbers, numerals, information, and/or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining”, “establishing”, “obtaining”, “identifying”, “selecting”, “generating”, and/or the like may refer to actions and/or processes of a specific apparatus, such as a special purpose computer and/or a similar special purpose computing device. In the context of this specification, therefore, a special purpose computer and/or a similar special purpose computing device is capable of processing, manipulating and/or transforming signals and/or states, typically represented as physical electronic and/or magnetic quantities within memories, registers, and/or other information storage devices, transmission devices, and/or display devices of the special purpose computer and/or similar special purpose computing device. In the context of this particular patent application, as mentioned, the term “specific apparatus” may include a general-purpose computing device, such as a general-purpose computer, once it is programmed to perform particular functions pursuant to instructions from program software.

While there has been illustrated and/or described what are presently considered to be example features, it will be understood by those skilled in the relevant art that various other modifications may be made and/or equivalents may be substituted, without departing from claimed subject matter. Additionally, many modifications may be made to adapt a particular situation to the teachings of claimed subject matter without departing from the central concept(s) described herein. Therefore, it is intended that claimed subject matter not be limited to the particular examples disclosed, but that such claimed subject matter may also include all aspects falling within appended claims and/or equivalents thereof.

1. A method comprising:
executing machine-readable instructions by one or more processing units to:
identify at least one discount of a group of discounts for at least one potential discount recipient of a group of potential discount recipients if a discount score meets or exceeds a threshold.

2. The method of claim 1, and further communicating the at least one identified discount to the at least one potential discount recipient while the at least one identified discount remains valid.

3. The method of claim 2, wherein communicating comprises at least one of a push communication or a pull communication.

4. The method of claim 2, wherein the executing to identify at least one discount for at least one potential discount recipient comprises identifying at least one discount for more than at least one potential discount recipient; and wherein the communicating comprises communicating the at least one identified discount to more than at least one potential discount recipient while the at least one identified discount remains valid.

5. The method of claim 2, wherein communicating comprises at least one of push communication or pull communication that depends at least in part on a particular potential discount recipient.

6. The method of claim 5, wherein the push communication comprises transmitting an email or text message.

7. The method of claim 5, wherein the pull communication comprises checking a website.

8. The method of claim 1, wherein the executing to identify at least one discount comprises identifying more than at least one discount.

9. The method of claim 1, wherein the executing to identify is additionally based, at least in part, on executing machine-readable instructions to employ factors to evaluate a host of discounts with respect to a host of potential discount recipients.

10. The method of claim 9, wherein the factors comprise preference-related indicators specific to particular potential discount recipients.

11. The method of claim 10, wherein the preference-related indicators comprise explicit or implicit preference-related indicators.

12. The method of claim 9, wherein the factors comprise commercial-related indicators specific to particular discounts.

13. The method of claim 12, wherein one or more commercial-related indicators comprise at least one of the following: locality, price range, merchant, product category, discount, validity period, or any combination thereof.

14. The method of claim 9, wherein the factors may comprise social-related indicators.

15. The method of claim 14, wherein the social-related indicators pertain, at least in part, to measurable features available by way of one or more social networks.

16. The method of claim 9, wherein one or more sources for the host of discounts comprises one or more sourcing agents.

17. The method of claim 9, wherein executing comprises normalizing discount scores across the host of discounts and across the host of potential recipients.

18. The method of claim 9, wherein the factors include a quality factor.

19. The method of claim 18, wherein the quality factor includes similar discounts previously accepted by one or more of the host of potential discount recipients.

20. The method of claim 18, wherein the quality factor includes sales velocity of a discount.

21. The method of claim 18, wherein the quality factor includes a reputation of a merchant offering a discount.

22. The method of claim 18, wherein the quality factor includes a reputation of a sourcing agent for a discount.

23. An apparatus, comprising:
one or more processors to:
rank a plurality of discounts substantially in accordance with discount scores; and
communicate one or more ranked discounts to one or more potential recipient substantially in accordance with preference-related indicators.

24. The apparatus of claim 23, wherein the one or more ranked discounts is to be communicated only if the one or more ranked discounts have a ranking within a top number of ranked discounts.

25. The apparatus of claim 23, wherein the one or more processors is additionally to access one or more publicly available databases or websites about one or more merchants offering one or more discounts to produce discount scores and an associated ranking of discounts.

26. The apparatus of claim 25, wherein the databases or websites comprise commercial databases or websites or government databases or websites.

27. The apparatus of claim 23, wherein the one or more processors is additionally to access one or more social networks or websites for feedback submitted by users of the one or more social networks about one or more merchants offering one or more discounts to produce discount scores and an associated ranking of discounts.

28. The apparatus of claim 23, wherein indicators comprise at least one of the following: sales velocity, number of times a similar discount has been accepted, age of a discount, or any combination thereof.

29. An article comprising:
a non-transitory storage medium comprising machine-readable instructions stored thereon which are executable by one or more processors to:
rank a plurality of discounts substantially in accord with discount scores; and
communicate one or more ranked discounts to one or more potential recipient substantially in accordance with preference-related indicators.
